(19) United States
(12) Patent Application Publication
(10) Pub. No.: US 2005/0244786 A1
(43) Pub. Date: Nov. 3, 2005

(54) Dental finishing device

(76) Inventor: George Freedman, Richmond Hill (CA)

Correspondence Address: WILDMAN HARROLD ALLEN & DIXON, 225 WEST WACKER DRIVE, SUITE 2800, CHICAGO, IL, 60606, US

(21) Appl. No.: 10/833,561

(22) Filed: Apr. 28, 2004

(51) Int. Cl. A61C 3/06

(52) U.S. Cl. 433/142

(57) ABSTRACT

A dental finishing device for the finishing, polishing or reduction of a tooth or tooth filling material having an elongated flexible strip with a curved shape along the length of the flexible strip. An abrasive coating is disposed on the surface of the flexible strip forming an abrasive portion on the strip surface. An abrasive-free access portion is positioned adjacent to the abrasive portion and is positioned towards an end of the flexible strip. The flexible strip has a concave side and a convex side which extend along at least a portion of the length of the flexible strip.

### BACKGROUND OF THE INVENTION

Dental finishing strips have been used for various dental procedures such as finishing, polishing and reduction of teeth, teeth filling material or teeth restorative material. Such finishing strips are generally flexible thin metal or plastic strips having diamonds or other abrasive materials disposed on one side or both side surfaces of the strip such that an active or abrasive region of the strip is formed. Certain finishing strips provide an access area without any abrasive material on the surface which is positioned in the middle or center of the strip dividing the strip into two separate abrasive regions whereby the strip is inserted between adjacent teeth of a patient through the non-abrasive access area. Once the finishing strip is positioned it is pulled through the teeth to allow the diamond material move across the surface of a tooth. For instance, a finishing strip may be used for removing excess material or contouring regions of a filling and creating a smooth surface of the filling material. Finishing strips have also been used for polishing fillings, crowns and the like.

Conventional finishing strips are not only thin and flat, they are also straight. In particular, the longitudinal sides of conventional finishing strips are straight such that they both extend in a straight direction across the length of the strip. When in use, a flat and straight finishing strip often has its abrasive surface positioned for movement across a relatively rounded surface of the side of a tooth. The straight finishing strip positioned against a rounded tooth surface may result in a flared out portion of the strip which does not contact the tooth. This may result in the dentist using the finishing strip on one portion of the tooth and then inserting, positioning and using the finishing strip again on another portion of the tooth that may have been initially missed by the flared out portion of the finishing strip. The use of a straight finishing strip may also flatten out an area of a tooth that should remain round. Additionally, because a portion of the strip may be flared out from contact with the tooth, efforts are needed to be made by the dentist to avoid movement of the abrasive portion of the strip over the gum tissue and gingival region of the patient.

### SUMMARY OF THE INVENTION

A dental finishing device for the finishing, polishing or reduction of a tooth or a tooth filling material is provided with an elongated flexible strip having a curved shape along the length of the flexible strip. An abrasive coating is deposited on at least one elongated surface of the flexible strip to form an abrasive portion on the strip surface. An uncoated abrasive-free access portion is positioned adjacent to the abrasive portion and towards an end of the flexible strip. The flexible strip has a concave side and a convex side which extend along at least a portion of the length of the flexible strip.

### BRIEF DESCRIPTION OF THE DRAWINGS

FIG. 1 is a front view illustrating a working surface of one embodiment the dental finishing device.

FIG. 2 is a front view illustrating a working surface of another embodiment of the dental finishing device.

FIG. 3 is a front view illustrating a working surface of another embodiment of the dental finishing device.

FIG. 4 is a perspective view illustrating the dental finishing device of FIG. 1 being used in the mouth of a patient.

### DETAILED DESCRIPTION

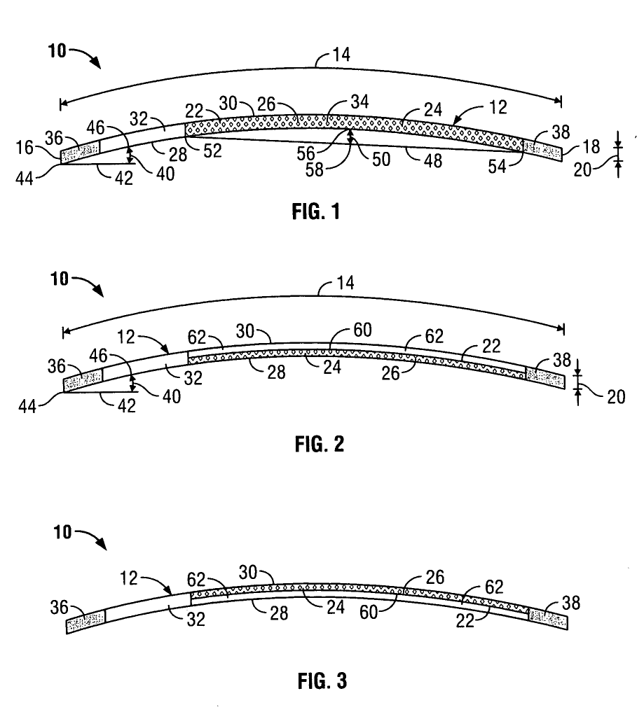

Referring to FIG. 1, dental finishing device 10 for the abrasion of a tooth, a tooth filling material or any tooth restorative material is shown. The dental finishing device 10 has a thin elongated flexible strip 12 with a length 14 extending between two ends 16, 18 and has a width 20 as seen in FIG. 1. The elongated flexible strip 12 has a pair of elongated surfaces, a working surface 22 as seen in the example of FIG. 1 and a smooth backing surface 23 (FIG. 4). The elongated flexible strip 12 may selectively be comprised of a corrosion-resistant metal such as stainless-steel, titanium or other metals, or alternatively plastic.

An abrasive coating 24, as seen in FIG. 1, on the working surface 22 forms an abrasive portion 26 on the elongated flexible strip 12. The abrasive portion 26 on surface 22 of flexible strip 12 is used for finishing, polishing and/or reduction of a tooth or tooth filling material. The abrasive coating 24 generally will employ multiple grains of diamond material (for example having grain sizes ranging from 8 to 90 μm); however, other suitable abrasive materials such as ceramics, glass, resins or similar materials may selectively be utilized. In the example of FIG. 1, an abrasive portion is provided on one of the pair of elongated lateral surfaces (e.g., working surface 22); however, in alternative embodiments abrasive coatings forming abrasive portions may selectively be placed on both of the elongated lateral surfaces of the flexible strip. As seen in FIG. 1, flexible strip 12 has a curved shape along the length 14 of the strip.

In the example seen in FIG. 1, the flexible strip 12 is arc shaped with a concave side 28 as well as a convex side 30 extending along the length of the strip 12. As seen in FIG. 1, the concave side 28 and the convex side 30 both extend continuously along the entire length 14 of the flexible strip 12. The concave side 28 and the convex side 30 are located on opposite sides of the flexible strip 12 and are substantially parallel to one another. Referring to FIG. 4, the flexible strip 12 in the embodiment of FIG. 1 is shown, being used on a tooth 64 in the mouth 66 of a dental patient. In this embodiment, the abrasive coating 24 is provided on the working surface 22 and the strip has a smooth backing surface 23. The curved and generally arced shape of the flexible strip 12 is designed to conform to the rounded proximal and cervical anatomy of a natural tooth 64. When in use during the stripping process, the curved shape keeps the strip, (including its abrasive portion 26) more flush with the tooth surface (as seen in FIG. 4) and away from the gingiva 68, reducing the chances of soft tissue trauma, and preventing inadvertent bleeding that makes strip polishing and visibility more difficult as the process is continued. The curved surface of the strip 12 provides for intimate contact of the abrasive portion 26 with the rounded surface of a tooth (or tooth filling) which leads to increased uniformity in finishing, polishing and reduction. The curved surface of the strip will contact more of the rounded tooth surface that is intended to be abraded thus making the action of polishing or abrading more effective and/or faster.

The flexible strip 12, as seen in FIG. 1, has access portion 32 which is an uncoated abrasive-free portion positioned adjacent to the abrasive portion 26 and positioned towards an end 16 of the strip. In the example seen in FIG. 1, the working surface 22 of the flexible strip 12 has a single abrasive portion 26 extending across the majority of the length 14 of the strip and also has a single access portion 32 adjacent the abrasive portion to allow the strip to be inserted and positioned between teeth (without abrading the contact point of the teeth, filling materials, or dental restorative materials) prior to pulling and movement of the strip during the stripping process. As seen in the example of FIG. 1, the abrasive coating 24 extends across the entire width 20 of the working surface 22 at the abrasive portion 26 of the strip 12. Additionally, the abrasive portion 26 extends across the majority of the length 14 of the working surface 22 of the strip 12 including across a middle section 34 of the working surface of the strip. By placing the access portion 32 towards an end 16 of the flexible strip 12 and having the abrasive portion 26 extending across the majority of the strip length (including the middle section of the strip), effective and efficient use of the strip is achieved.

The working surface 22 of the flexible strip 12, in the example seen in FIG. 1, has a pair of color portions 36, 38 in which one color portion 36 is adjacent to end 16 and color portion 38 is adjacent to the other end 18 of the flexible strip. Access portion 32 is positioned between color portion 36 and abrasive portion 26, and the abrasive portion 26 is positioned between the access portion 32 and the other color portion 38. Alternatively, a single color portion may be employed. The color portions 36, 38 are used to provide an indication to the user (such as a dentist) as to the coarseness (or fine) level of the abrasive material used in the abrasive coating thereby representing the particular type of finishing strip. Additionally, the nature of the finishing strip device (e.g., whether it is a total cutting or a partial cutting strip) may be identified by the particular color portion(s). When in use, the flexible strip 12 is inserted between the teeth whereby the concave side 28 is positioned more towards a crown of a tooth relative to the convex side 30. This positioning of the curved flexible strip 12 applies for the insertion of the strip between the lower teeth as well as the upper teeth (as seen in FIG. 4) such that the concave side 28 will be placed closer to the occlusal (relative to the convex side) and the convex side 30 will be placed closer to the gingival area (relative to the concave side).

As seen in the example of FIG. 1, the curved shape of the flexible strip 12 has a gradual, slightly arced shaped bend as the strip extends from end 16 to end 18. The curved shape of the flexible strip 12 provides for an initial angle 40 that is measured between a horizontal base line 42 extending from an end 44 of the concave side 28 of the strip to a point 46 located on the concave side. The point 46 on the concave side 28 at which the initial angle 40 is measured is generally at a distance from the end 44 of the concave side 28 that is less than one fifth of the total length of the concave side. The initial angle 40 measured between the horizontal base line 42, end 44 of the concave side 28, and the preselected point 46 on the concave side in one example may selectively range from five degrees to thirty degrees. Alternatively, the initial angle may range from ten to twenty degrees. In particular, the initial angle 40 for the concave side 28 may selectively range from 13° to 17° and more particularly the initial angle may selectively be approximately 15° as seen in the examples in FIGS. 1 and 2.

As seen in FIG. 1, the flexible strip 12 has a curved shape such that a chord 48 is formed by extending a line from one end 52 of the abrasive portion 26 at the concave side 28 to another end 34 of the abrasive portion of the concave side. The curved shape along the length of the abrasive portion 26 in the example of FIG. 1 is a gradual and continuous curved shape such that the distance 56, measured from a midpoint 58 of the chord 48 along a line 50 (normal to the chord) to the concave side 28, is less than ten percent of the length of the chord 48. For instance, in one example, the distance 56 from the midpoint 58 of the chord 48 along line 50 to the concave side 28 is approximately 0.3 cm and the length of the chord 48 is approximately 9 cm resulting in the distance 56 being approximately 3.3% of the length of the chord 48 across the concave side 28 of the abrasive portion 26. In other examples, the distance 56 along line 50 may selectively range from 1%-8% of the length of the chord 48.

Referring now to FIG. 2, another embodiment of the dental finishing device 10 is shown in which the abrasive coating 26 of the abrasive portion 28 extends across less than the total distance of the width 20 of the flexible strip 12. In the example seen in FIG. 2, the abrasive coating 24 extends for approximately one half of the width 20 of the flexible strip 12. The abrasive portion 26 extends continuously from the concave side 28 to an area 60 proximate the center of the width 20 of the flexible strip 12. The remaining area 62 across the width 20 to the convex side 30 of the flexible strip 12 is uncoated and abrasive-free, preferably having the same or a similar texture as the access portion 32. In other examples, the abrasive coating 26 may selectively extend between thirty-three percent (33%) and seventy-five percent (75%) across the total width 20 of the flexible strip 12. An abrasive portion 28 may extend partially across the width of one of the pair of elongated surfaces of the strip (as seen in FIG. 2) or alternatively partially across the width of both of the pair of elongated lateral surfaces of the strip such that an abrasive coating may selectively extend between 33 percent and 75 percent across the total width of both lateral surfaces (front and back surfaces) of the flexible strip. By having an abrasive portion 28 extending partially across the width of the flexible strip and a non-abrasive area 62 across the remainder of the strip width 20, the finishing device 10 may strip an area on a tooth surface that is apical to an interproximal contact point without damaging or potentially destroying the contact point itself. The flexible strip 12 of FIG. 2, is positioned between the teeth such that the non-abrasive area 62 may selectively move across the contact point and the abrasive portion 26 will move across the tooth surface or tooth filling material that is intended to be stripped.

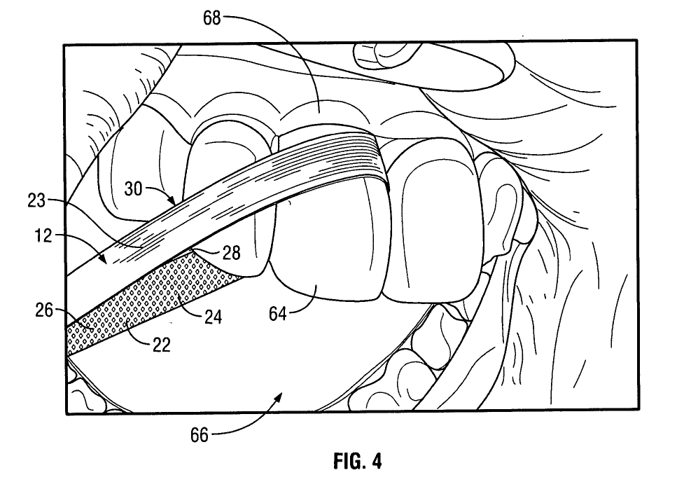

Referring now to FIG. 3, another embodiment of the dental finishing device 10 is shown which is similar to the embodiment of FIG. 2 except the abrasive coating 26 of the abrasive portion extends continuously from the convex side 30 to an area proximate the center of the width of the flexible strip 12. In this embodiment, the remaining area 62 across the width 20 to the concave side 28 of the strip is uncoated and abrasive-free. In other examples, the abrasive coating may selectively extend between 33% and 75% across the total width of the flexible strip from the convex side 30. In this embodiment, an abrasive portion 28 may selectively extending partially across the width of either one or both of the elongated lateral surfaces 22, 23 of the strip 12.

Although certain embodiments have been depicted and described in detail herein, it will be apparent to those skilled in the relevant art that various modifications, additions, substitutions and the like can be made without departing from the spirit of the invention and these are therefore considered to be within the scope of the invention. While a detailed description of certain embodiments has been provided, it should be appreciated that many variations can be made thereto without departing from the scope of the appended claims.

1. A dental finishing device for the abrasion of a tooth, a tooth filling material or a tooth restorative material, comprising:
an elongated flexible strip having a length extending between two ends, and having at least a pair of elongated surfaces; and
an abrasive coating on at least one of the elongated surfaces forming an abrasive portion on the flexible strip, and in which the flexible strip has a curved shape along at least a portion of the length of the flexible strip.

2. The dental finishing device of claim 1 in which the curved shape is arc shaped.

3. The dental finishing device of claim 1 in which the flexible strip has a concave side which extends along at least a portion of the length and a convex side which extends along at least a portion of the length of the flexible strip.

4. The dental finishing device of claim 3 in which the concave side extends substantially continuously along the entire length of the flexible strip and the convex side extends substantially continuously along the entire length of the flexible strip.

5. The dental finishing device of claim 4 in which the concave side and the convex side are located on opposing sides of the flexible strip and are substantially parallel to one another.

6. The dental finishing device of claim 3 in which an initial angle for the concave side measured from a horizontal base extending from one end of the concave side ranges from 5° to 30°.

7. The dental finishing device of claim 6 in which the initial angle is measured between the horizontal base line extending from the one end of the concave side and a point that is located on the concave side at a distance from the one end which is less than one fifth of the total length of the concave side.

8. The dental finishing device of claim 7 in which the initial angle for the concave side ranges from 10° to 20°.

9. The dental finishing device of claim 7 in which the initial angle for the concave side ranges from 13° to 17°.

10. The dental finishing device of claim 7 in which the initial angle for the concave side is approximately 15°.

11. The dental finishing device of claim 3 in which the abrasive coating extends across substantially an entire width of the at least one elongated surface of the flexible strip.

12. The dental finishing device of claim 11 in which the abrasive portion extends across the majority of the length of the elongated surface including across a middle section of the one lateral surface of the flexible strip.

13. The dental finishing device of claim 12 in which the flexible strip is curved shaped such that a chord is formed by extending a line from one end of the abrasive portion at the concave side to another end of the abrasive portion of the concave side and a distance measured from a midpoint of the chord along a line, normal to the chord, to the concave side is less than ten percent (10%) of the length of the chord.

14. The dental finishing device of claim 12 including an access portion which is an uncoated abrasive-free portion positioned adjacent to the abrasive portion and towards an end of the flexible strip.

15. The dental finishing device of claim 14 in which the elongated surface of the flexible strip has a single abrasive portion extending across the majority of the length of the flexible strip and also has a single access portion.

16. The dental finishing device of claim 12 in which the elongated surface of the flexible strip has a pair of color portions in which one color portion is adjacent one of the ends of the flexible strip and the other color portion is adjacent the other end of the flexible strip such that the single access portion is disposed between the one color portion and the single abrasive portion, and the single abrasive portion is disposed between the single access portion and the other color portion.

17. The dental finishing device of claim 3 including an access portion which is an uncoated abrasive-free portion positioned adjacent to the abrasive portion and positioned closer to one of the ends of the flexible strip than to a midpoint of the length of the flexible strip.

18. The dental finishing device of claim 3 in which the abrasive coating of the abrasive portion extends across less than a total distance of a width of the flexible strip.

19. The dental finishing strip of claim 18 in which the abrasive coating of the abrasive portion extends for approximately one half the width of the flexible strip.

20. The dental finishing strip of claim 18 in which the abrasive coating extends between thirty-three percent and seventy-five percent across the total width of the flexible strip.

21. The dental finishing strip of claim 20 in which both of the pair of elongated surfaces of the strip have abrasive portions such that the abrasive coating extends between thirty-three percent and seventy-five percent across the total width of both elongated surfaces of the flexible strip.

22. The dental finishing strip of claim 20 in which the abrasive portion extends continuously from the concave side to an area proximate a center of the width of the flexible strip.

23. The dental finishing strip of claim 20 in which the abrasive portion extends continuously from the convex side to an area proximate a center of the width of the flexible strip.

24. The dental finishing strip of claim 20 including an access portion which is an uncoated abrasive-free portion positioned closer to one of the ends of the flexible strip than to a midpoint of the length of the flexible strip.
